(19) United States
(12) Patent Application Publication
(10) Pub. No.: US 2015/0049037 A1
(43) Pub. Date: Feb. 19, 2015

(54) WRIST WORN DEVICE

(71) Applicant: ARM IP LIMITED, Cambridge (GB)

(72) Inventors: Hugo John Martin VINCENT, Cambridge (GB); Gábor BÁLINT, Cambridge (GB)

(21) Appl. No.: 14/462,926

(22) Filed: Aug. 19, 2014

(30) Foreign Application Priority Data
Aug. 19, 2013 (GB) 1314753.3

(51) Int. Cl. G06F 1/16; G06F 3/02; G06F 3/0354

(52) U.S. Cl. CPC G06F 1/163; G06F 3/03547; G06F 3/0202; G06F 1/169
USPC 345/173

(57) ABSTRACT

A wrist worn device includes a device body and a strap. A display screen is provided on the device body. The display screen is rotated relative to a normal to the display screen in a clockwise direction for a watch shaped to be worn on the left arm and in an anti-clockwise direction for a watch shaped to be worn on a right arm. A touch sensor is provided on a right edge of a watch for wearing on a left arm and a button sensor is provided on a lower left edge of a watch for wearing on a user's left arm. The touch sensor and the button sensor may be provided in a mirrored orientation on a watch for wearing on a user's right arm.

### FIELD OF THE INVENTION

This invention relates to the field of wrist worn devices. More particularly, this invention relates to measures to improve the ergonomics of wrist worn devices.

### DESCRIPTION OF THE PRIOR ART

It is known to provide wrist worn devices, such as smart watches, with display screens for displaying information to a user and with sensors/buttons to permit the user to interact with the wrist worn device. A wrist worn device must be relatively compact and this has the result that the display screens they may use are relatively small. Furthermore, the scope for the provision of different types of buttons/sensors is also constrained due to the physically small nature of a wrist worn device and the desire to avoid obscuring the display screen of that device when such buttons/sensors are manipulated.

### SUMMARY OF THE INVENTION

Viewed from one aspect the present invention provides a wrist worn device for wearing on a user's arm, said user's arm having a longitudinal arm axis, said wrist worn device comprising:

a device body; and

a strap coupled to said device body and configured to hold said wrist worn device to said user's arm, said wrist worn device being held in a resting position relative to said user's arm; wherein

said device body includes a display screen providing a two-dimensional array of pixels comprising rows of pixels and columns of pixels,

at each point on said display screen, said rows of pixels extend in a row direction, said columns of pixels extend in a column direction perpendicular to said row direction, and a normal outward from said display screen extends in a normal direction perpendicular to both said row direction and said column direction; and

said display screen is held within said device body such that, when said wrist worn device is in said resting position:
(i) said longitudinal arm axis is substantially perpendicular to said normal direction; and
(ii) said longitudinal arm axis has a non-zero row-direction component in said row direction and a non-zero column-direction component in said column direction corresponding to said display screen being rotated by a non-zero rotation angle about said normal relative to said longitudinal arm axis.

The present technique recognises that while a display screen comprising a two-dimensional array of pixels arranged in orthogonal rows and columns may be well suited to displaying a wide variety of different types of information, it suffers from the disadvantage of generating aliasing effects when straight lines are drawn other than parallel with the rows or parallel with the columns. Such aliasing effects degrade the quality of the image being presented. Many real life images to be displayed to a user include lines which are drawn either vertically or horizontally relative to the direction in which the user views the display. However, when a wrist worn device is being viewed, then it is natural/comfortable for the user to hold their forearm at an angle to the front face of their body. Accordingly, a line transverse to the user's forearm will be at an angle to what the user would naturally perceive as vertical and horizontal lines in their field of view. This could be compensated for by adjusting the angle at which the lines are drawn on the display screen of the wrist worn device so that it is not parallel to one of the column direction or the row direction, but then this would introduce undesired aliasing for such relatively common “vertical and horizontal” lines. Accordingly, the present technique addresses these problems by rotating the display of the wrist worn device such that the row direction and column direction on the display are rotationally offset from the longitudinal axis of the user's arms so as to bring the column direction and the row direction more closely to match the user's perception of a vertical direction and a horizontal direction when they are viewing the display. Thus, lines which appear close to vertical and horizontal to the user's view direction can be drawn parallel to the column direction and the row direction of the display and so image degradation due to aliasing can be reduced.

It will be appreciated that the display screen could take a variety of different forms. In some embodiments the display screen may be a flat plane. In other embodiments the display screen may be part of a curved cylindrical surface such that it surrounds and more closely conforms to a circumferential portion of the user's wrist. The display screens may be rigid or, in some embodiments flexible, at least in one direction of curvature.

It will be appreciated that the selection of the rotation angle by which the row direction and column direction are rotated is important so as to balance the degree to which lines drawn in the column direction and the row direction appear vertical and horizontal relative to the user weighed against the difficulty of accommodating such a rotated display within the other constraints associated with a wrist worn device. In some embodiments the rotation angle is greater than 4 degrees and less than 15 degrees. More preferably, the rotation angle is greater than 6 degrees and less than 10 degrees. Still more preferably, the rotation angle is substantially 8 degrees.

It will be appreciated that by rotating the display screen relative to the longitudinal arm axis to align the column direction and the row direction more closely to the perceived vertical and horizontal directions when viewed by the user, the wrist worn device is effectively made handed in that a wrist worn device adapted for wearing on a user's left arm is unsuitable for wearing on a user's right arm and vice versa. In embodiments where the wrist worn device is adapted for wearing on a user's left arm, the rotation angle is clockwise relative to the normal from the display face extending toward the viewer. Conversely, when the wrist worn device is adapted for wearing on a user's right arm, the rotation angle is anti-clockwise relative to the normal to the display surface.

It will be appreciated that in some embodiments the column direction of the screen may correspond to the vertical direction on the screen when viewed by the user (i.e. the column direction has its major component perpendicular to the longitudinal arm axis). However, in other embodiments it is possible that the row direction of the display could be arranged to correspond to the vertical direction in the user's view.

In some embodiments the column direction has a major column component perpendicular to said longitudinal arm axis and a minor column component parallel with said longitudinal arm axis, said major column component having a greater magnitude than said minor column component; and said row direction has a major row component perpendicular to said longitudinal arm axis and a minor row component parallel with said longitudinal arm axis, said major row component having a greater magnitude than said minor row component.

In some embodiments a line drawn parallel to said column direction on said display screen is rotated towards said longitudinal arm axis as said rotation angle increases, wherein said user has a front facing direction and said rotation angle rotates said line to be substantially parallel with said front facing direction when said user's arm is held in a viewing position non-perpendicular with said front facing direction.

When the column direction corresponds to the user's vertical direction, then the column direction will be rotated towards the longitudinal arm axis as the rotation angle increases. In such embodiments, the rotation angle may be selected to rotate the line parallel to the column direction to be substantially parallel with a front facing direction of the user when the user's arm is held in viewing position (non-perpendicular with the user's front facing direction), i.e. the user's arm is held at their side in a standard position for viewing a wrist worn device with the axis of the arm being across the body (non-perpendicular to the front facing direction of the user).

The present technique is particularly useful for wrist worn devices in which the display is used to display a frame of display data to which arbitrary pixel values for each pixel within the display may be written by a program(s) running on the wrist worn device. The wide variety of display patterns which may be drawn is best served by use of a display comprising a generic array of pixels of the same size and accordingly one which is potentially liable to aliasing for lines not drawn parallel to the column direction or the row direction. In some embodiments, a display memory is provided configured to store a frame of display data and display driver circuitry is provided configured to drive said display screen to display said frame of display data. Furthermore, in some embodiments, processing circuitry is provided configured to execute programs and wherein said display memory permits said programs to write arbitrary pixels values for each pixel within said display screen.

Viewed from another aspect the present invention provides a wrist worn device for wearing on a user's arm, said user's arm having a longitudinal arm axis, said wrist worn device comprising:

device body means for holding processing circuitry; and

strap means for holding said wrist worn device to said user's arm, said wrist worn device being held in a resting position relative to said user's arm; wherein

device body means includes display screen means for displaying a two-dimensional array of pixels comprising rows of pixels and columns of pixels,

at each point on said display screen means, said rows of pixels extend in a row direction, said columns of pixels extend in a column direction perpendicular to said row direction, and a normal outward from said display screen extends in a normal direction perpendicular to both said row direction and said column direction; and

said display screen means is held within said device body means such that, when said wrist worn device is in said resting position:
(i) said longitudinal arm axis is substantially perpendicular to said normal direction; and
(ii) said longitudinal arm axis has a non-zero row-direction component in said row direction and a non-zero column-direction component in said column direction corresponding to said display screen being rotated by a non-zero rotation angle about said normal relative to said longitudinal arm axis.

Another problem with wrist worn devices is the positioning of the buttons/sensors used to interact with those wrist worn devices. The positioning of these buttons is constrained by the small size of a wrist worn device and the desirability of not obscuring a display of the wrist worn device during operation of the button/sensors.

Viewed from another aspect the present invention provides a wrist worn device for wearing on a user's left arm, said wrist worn device comprising:

a device body having a main face bearing a display and surrounded by body edges;

a scroll sensor disposed on a first edge of said device body and configured to detect a sliding touch input, said first edge being proximal to a right portion of said display relative to a viewing direction of said display;

a button sensor disposed at a button position on said device and configured to detect a push input, said button position being proximal to a lower left portion of said display relative to a viewing direction of said display.

The present technique recognises that if a wrist worn device is made handed (adapted for wearing on a particular one of a user's left arm or right arm), then an improvement in the ease with which a user may interact with that wrist worn device may be achieved when the device is provided with a scroll sensor proximal to a right portion of the display relative to a viewing direction of the display and a button positioned proximal to a lower left portion of the display relative to a viewing direction of the display. The user's right hand seeking to interact with a wrist worn device on a user's left arm may naturally rest with the right index finger on the right edge of the device and with the right thumb at the lower left portion of the device. This natural positioning allows the user to control both the scroll sensor and the button while holding their left arm and their right hand in a comfortable position and without obscuring a view of the display.

In some embodiments the scroll sensor may be positioned to extend along a facet of the device body with the facet having at least one facet edge parallel to a direction of the sliding touch input. This facet edge may be used as a tactile guide to the sliding touch input by the user and so guide the user's finger motion in a way to properly drive the scroll sensor.

In some embodiments the facet may have two parallel facet edges parallel to the sliding touch input with the scroll sensor being disposed therebetween. Two such parallel facet edges provide tactile input whereby both edges may be felt by the user's finger and so increase the likelihood that the user will position their finger correctly and move their finger correctly along the scroll sensor.

In order for a more natural and comfortable interaction with the scroll sensor, embodiments may be provided in which the facet is positioned with a face angle between a normal to the display extending toward the user and an outward facing normal to the facet such that the facet angle has a value between 40 and 60 degrees. In other embodiments, the facet angle may have a value between 45 and 55 degrees. In a still further embodiment, the facet angle may have a value of substantially 50 degrees.

The push input of the button sensor may have a variety of different orientations relative to the wrist worn device. In preferred embodiments the push input has a push vector with non-zero components directed towards the top portion of the display, the right portion of the display and into the display parallel to a normal to the display. Having a push input direction with this orientation is more natural for a user when their hand is positioned with the thumb to one side of the device.

The amount by which the push vector is angled relative to a normal to the display may be characterised by an inward display-normal angle. This angle may have a value of between 66 and 86 degrees. More specifically, this inward display-normal angle may have a value of between 71 and 81 degrees. In particular embodiments the inward display-normal angle may have a value of substantially 76 degrees.

The wrist worn device may include a strap which is coupled to the device body and configured to hold the wrist worn device to the user's arm in a normal resting position relative to the user's arm and a longitudinal arm axis of the user's left arm (or right arm for the complementary device). The strap and device body thus effectively control the orientation with which the wrist worn device is held relative to the longitudinal arm axis of the user when the wrist worn device is worn by the user and its at its resting position relative to the user's arm. The inner surfaces of the strap and the device body contact the arm and extend substantially parallel to the longitudinal arm axis.

In the context of the device having a resting position relative to the longitudinal arm axis, the orientation of the push input relative to the device may be characterised by an inward display-parallel angle that is an angle between a component of the push vector parallel to the face of the display proximal to the push button and direction of the longitudinal arm axis that is projected into the face proximal to the push button. This push vector is directed toward the centre of the display and the inward display-parallel angle defines more accurately this direction.

In some embodiments the inward display-parallel angle has a value of between 36 and 56 degrees, In other embodiments the inward display-parallel angle has a value of between 41 and 51 degrees. In particular embodiments the inward display-parallel angle is substantially 46 degrees.

Positioning of the button with its push input direction angled into the face of the watch and towards the centre of the watch introduces some practical difficulties in enabling that push input to be detected by the circuitry of the wrist worn device. In some embodiments the wrist worn device includes a printed circuit layer within the device body having a major surface and a printed-circuit button fixed to this major surface. A lever fixed to the printed circuit layer and bearing upon the printed-circuit button may be additionally provided. The push input may bear upon this lever, with the lever and the printed-circuit button may be configured such that when the push input drives a pivoting motion of the lever, the lever actuates the printed-circuit button. Thus, the lever may be used as an intermediary to convert the push input direction into a direction more convenient for a printed-circuit button to accurately and reliably detect.

Viewed from another aspect the present invention provides a wrist worn device for wearing on a user's left arm, said wrist worn device comprising:

device body means for housing device components , said device body means having a main face bearing display means for displaying an image, said device body means being surrounded by body edges;

scroll sensor means for detecting sliding touch input, said scroll sensor means being disposed on a first edge of said device body means, said first edge being proximal to a right portion of said display means relative to a viewing direction of said display means;

button sensor means disposed at a button position on said device body and configured to detect a push input, said button position being proximal to a lower left portion of said display means relative to a viewing direction of said display means.

It will be appreciated that in addition to providing embodiments of the invention adapted for wearing on a user's left arm with the button sensor and the scroll sensor adapted for operation by a user's right hand, it is also possible to provide a complementary form of wrist worn device adapted for wearing on a user's right arm. Accordingly, in accordance with another embodiment of the invention there is provided a wrist worn device for wearing on a user's right arm, said wrist worn device comprising:

a device body having a main face bearing a display and surrounded by body edges;

a scroll sensor disposed on a first edge of said device body and configured to detect a sliding touch input, said first edge being proximal to a left portion of said display relative to a viewing direction of said display;

a button sensor disposed at a button position on said device and configured to detect a push input, said button position being proximal to a lower right portion of said display relative to a viewing direction of said display.

In another aspect there is provided a wrist worn device for wearing on a user's arm, said wrist worn device comprising: a device body having a main face bearing a display and surrounded by body edges;

a scroll sensor disposed on a first edge of said device body and configured to detect a sliding touch input, said first edge being proximal to a left or right portion of said display relative to a viewing direction of said display; and a button sensor disposed on said device and configured to detect a push input.

In some embodiments, said scroll sensor is disposed on a first edge of said device body and configured to detect a sliding touch input, said first edge being proximal to a right portion of said display relative to a viewing direction of said display; and

wherein said button sensor is disposed at a button position on said device, said button position being proximal to a lower left portion of said display relative to a viewing direction of said display.

In some embodiments, said scroll sensor is disposed on a first edge of said device body and configured to detect a sliding touch input, said first edge being proximal to a left portion of said display relative to a viewing direction of said display; and

wherein said button sensor is disposed at a button position on said device, said button position being proximal to a lower right portion of said display relative to a viewing direction of said display.

### BRIEF DESCRIPTION OF THE DRAWINGS

Embodiments of the invention will now be described, by way of example only, with reference to the accompanying drawings in which:

FIG. 1 schematically illustrates a wrist worn device at its resting position or a user's left arm in plan view;

FIG. 2 schematically illustrates the wrist worn device on a user's left arm in side view;

FIG. 3 schematically illustrates a wrist worn device on a user's left arm with a display in the form of a portion of a curved cylindrical surface;

FIG. 4 schematically illustrates a wrist worn device at a resting position on a user's right arm;

FIG. 5 schematically illustrates circuitry forming part of a wrist worn device;

FIG. 6 schematically illustrates how aliasing effects can arise for lines of different orientations drawn on a display screen;

FIG. 7 is a plan view of a wrist worn device adapted for wearing on a user's left arm and incorporating a button sensor and a scroll sensor;

FIG. 8 is a side view of the device of FIG. 7;

FIG. 9 schematically illustrates the inward display-normal angle between a push direction of a button on a wrist worn device and a normal to the display;

FIG. 10 schematically illustrates the use of a lever to convert a push direction of a button sensor into a motion to actuate a printed-circuit button within a wrist worn device; and

FIGS. 11 to 24 schematically illustrate various views of a wrist worn device adapted for wearing on a user's left arm and a wrist worn device adapted for wearing on a user's right arm.

### DESCRIPTION OF THE EMBODIMENTS

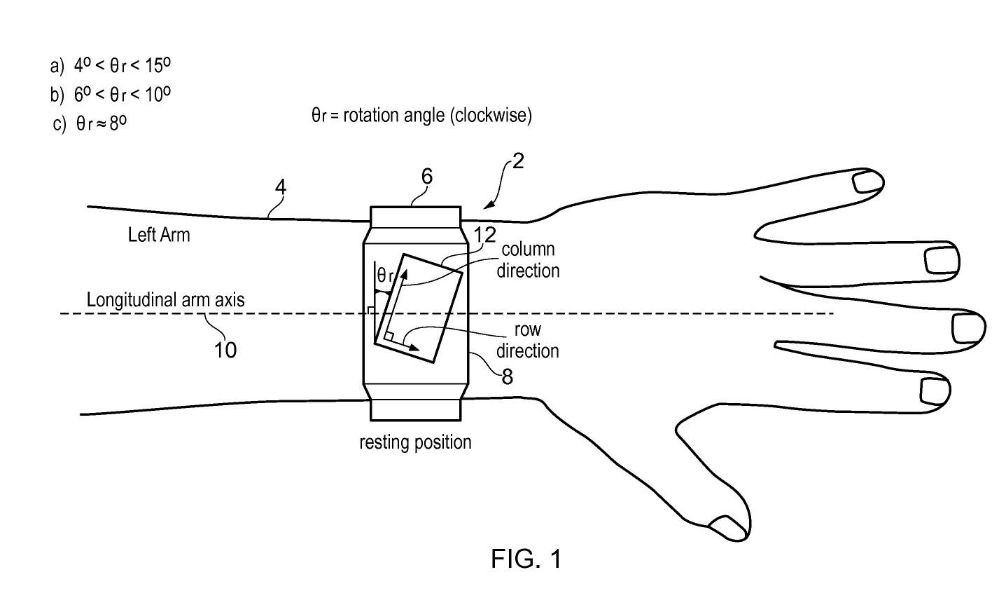

FIG. 1 schematically illustrates a wrist worn device 2 with a form matched to wearing on a user's left arm 4. The wrist worn device 2 is illustrated at its resting position on the left arm 4 where it is held by a strap 6 and the device body 8. In this resting position the wrist worn device 2 has a substantially fixed orientation relative to the longitudinal arm access 10 of the user's left arm. The orientation of the inner surfaces of the strap 6 and the device body 8 hold the wrist worn device 2 in this resting position.

The wrist worn device 2 includes a display screen 12 that is part of the device body 8. The display screen 12 provides a two-dimensional array of pixels comprising rows of pixels extending in a row direction and columns of pixels extending in a column direction. The row direction and the column direction are orthogonal to each other at each point on the surface of the display screen 12. The pixels are of a regular size and shape (individual neighbouring pixels may be of different shapes depending upon the display technology being used, but the pixel area within the array to which they correspond will be the same as their neighbours such that the display can be considered as being divided into an array of regular pixels with orthogonal rows and columns). The display screen 12 may use a variety of different display technologies, such as LCD, OLED, E-Ink etc. Regular two-dimensional arrays of pixels are well suited to displaying general purpose images of the type which may be generated by a program(s) executing on the wrist worn device 2, such as a smart watch.

As will be seen in FIG. 1, the display screen 12 is rotated by a rotation angle ⊖ᵣ in a clockwise direction about a normal to the surface of the display screen 12 and relative to the longitudinal arm axis 10, or perpendicular to the longitudinal axis 10. The value of the rotation angle ⊖ᵣ can vary within the ranges shown. This rotation results in both the column direction having a non-zero component in the longitudinal arm axis direction and the row direction having a non-zero component in the longitudinal arm axis direction. If the display screen 12 is not rotated by the rotation angle ⊖ᵣ, then the column direction would be perpendicular to the longitudinal arm axis and the row direction would be parallel with the longitudinal arm axis. The normal to the display screen 12 is substantially perpendicular to the longitudinal arm axis. The rotation ⊖ᵣ is applied to the entire display screen 12 whether this is formed as a flat plane or as a section of a curved cylindrical surface (such as using flexible screen technology which is able to bend in one direction). Rotating the display screen 12 such that the top portion of the display screen 12 as illustrated in FIG. 1 moves towards the user's left hand has the effect that when the user's arm is held in a standard comfortable position for viewing the wrist worn device 2 (i.e. diagonally across the user's body), the display screen 12 is rotated clockwise relative to the user's view of the display screen 12 such that lines drawn purely in the column direction with no row direction component appear more in a direction directly away from and toward the user while lines drawn in the row direction appear more directly transverse to the user, at least from the user's viewing direction of the display screen 12. Thus, lines which it is desired to draw on the display screen 12 such that they appear parallel to a direction directly away from or towards the user's point of view or directly perpendicular to that point of view may be drawn on the display screen 12 purely in the column direction or in the row direction on the rotated display screen 12 thereby avoiding aliasing effects which could otherwise degrade such lines.

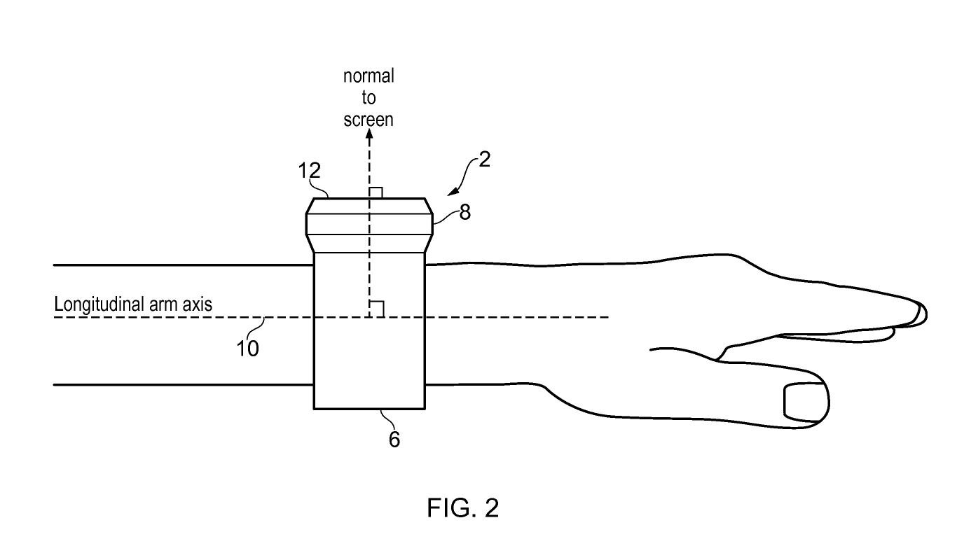

FIG. 2 shows a side view of the wrist worn device 2 (smart watch) with the strap 6 and the device body 9 holding the wrist worn device 2 at its normal resting position on a user's left arm. The thumb of the user is to the front in this view. This view illustrates that the normal to the display screen 12 is substantially perpendicular to the longitudinal arm axis 10.

It will be appreciated that minor differences in the positioning or form of a wrist worn device may result in various directions described herein not being exactly perpendicular or parallel to each other in the purely mathematical sense and such tolerances around exact angles are encompassed by the present techniques as will be appreciated by those in this technical field.

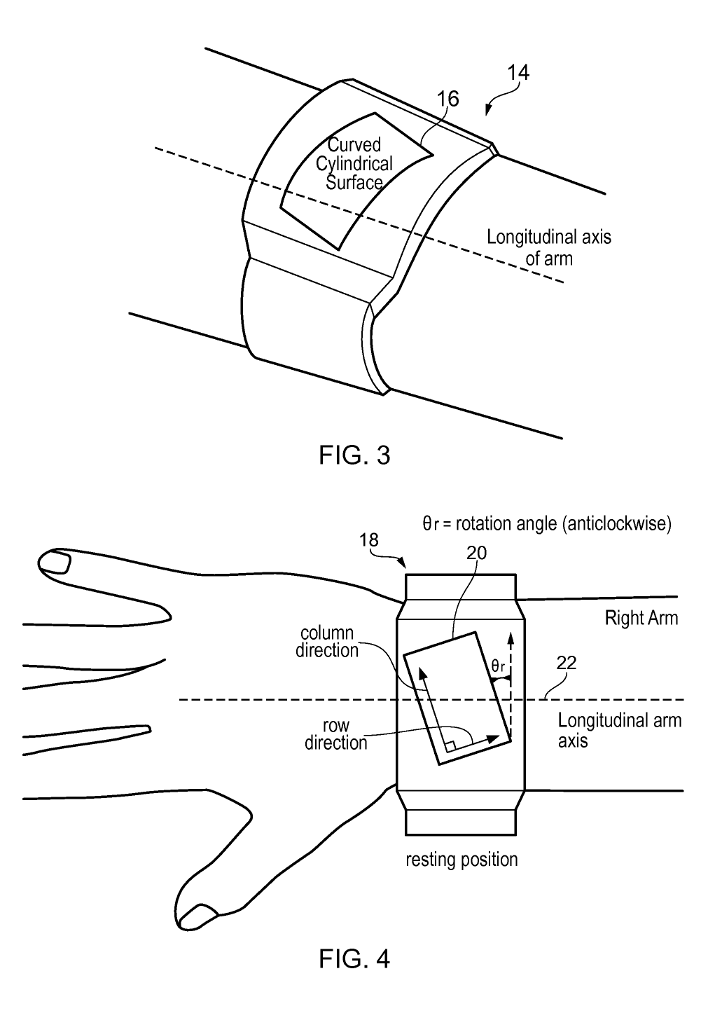

FIG. 3 schematically illustrates an example embodiment of a wrist worn device 14 having a display screen 16 which is part of a curved cylindrical surface. It is known to provide curved display screens, and even display screens that are flexible in one direction such that they may be curved about an axis perpendicular to that direction. The curved cylindrical surface in the case where the display screen 16 has been rotated by the rotation angle described previously will correspond to a section of a cylindrical surface cut at an angle to the axis of symmetry of that cylindrical surface. At each point on the curved cylindrical surface of the display screen 16, the row direction and the column direction are rotated by a rotation angle ⊖ᵣ so as to align these more naturally with the viewing direction of a user of the wrist worn device 14.

FIG. 4 schematically illustrates a wrist worn device 18 with a complementary form to that illustrated in FIG. 1 and intended for wearing on a user's right arm (e.g. for a left-handed user). In this case the strap 6 and device body 8 of the wrist worn device 18 are formed such as to give the wrist worn device 18 a resting position relative to the longitudinal arm access of the right arm. The display screen 20 in this circumstance is rotated anti-clockwise by the rotation angle ⊖ᵣ. This results in the column direction and the orthogonal row direction on the display screen 20 having a non-zero component in the longitudinal arm access direction 22. Another way of expressing this is that the longitudinal arm axis direction 22 has a non-zero component in the column direction and in the row direction. This equivalence will be the well understood by those in this technical field.

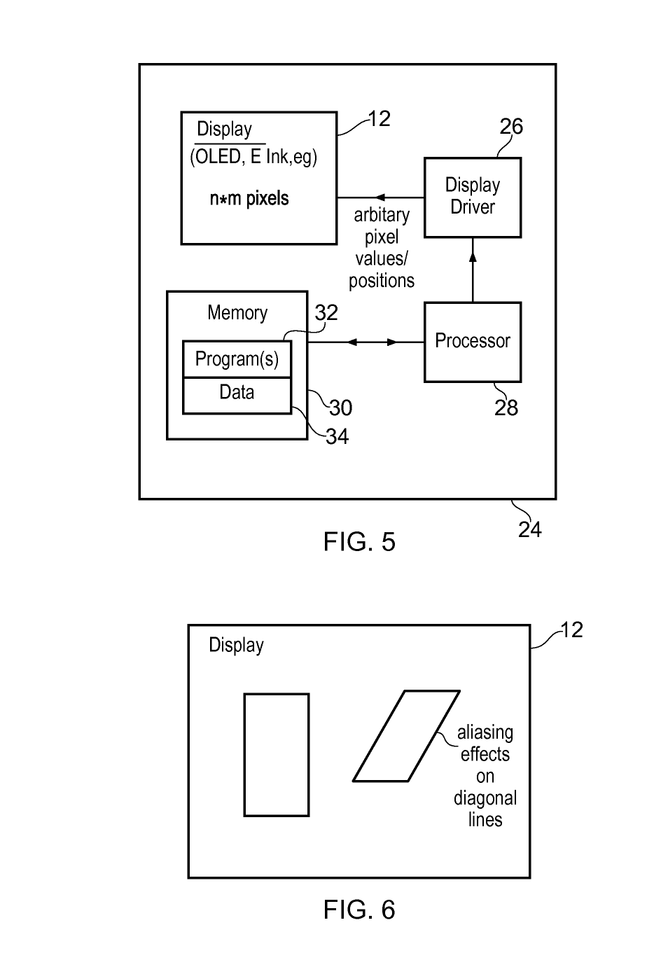

FIG. 5 schematically illustrates circuitry 24 located within the wrist worn device 2. This circuitry 24 includes the display screen 12, display driver circuitry 26, a processor 28 and a memory 30. The memory 30 stores one or more programs 32 as well as data 34 to be manipulated by those programs when executed by the processor 28. The processor 28 generates a frame of display data which may be stored within the memory 30 and then used by the display driver 26 to drive the display 12. The display 12 may be addressed on a pixel-by-pixel basis in order to enable a program or programs executed by the processor 28 to write arbitrary pixel values for each pixel within the display screen.

It will be appreciated that the rotation angle ⊖ᵣ illustrated in FIGS. 1 and 4 can have a variety of values. In some embodiments this rotation angle may be greater than 4 degrees and less than 15 degrees. In some embodiments this rotation angle may be greater than 6 degrees and less than 10 degrees. In a particular embodiment the rotation angle may be substantially 8 degrees. The size of the rotation angle may be selected to balance the degree to which lines drawn purely in the column direction or the row direction on the display screen 12 appear to be directly towards or away from a user's view, or perpendicular to that direction, weighed against the ability to locate such a rotated display screen 12 within the device body 8 with the device body 8 not becoming too large or unwieldy.

FIG. 6 schematically illustrates the display screen 12 with images drawn upon it. The left hand image comprises a rectangle which is drawn purely with lines extending in the column direction or the row direction. The right hand image shown in the display screen 12 is a parallelogram in which two of the sides are diagonal lines including a component in both the column direction and the row direction. Such diagonal lines are subject to aliasing effects which decrease the image quality. By rotating the display screen 12 relative to the longitudinal axis of the arm of the user when the wrist worn device is worn in its resting position, images which are intended to be viewed as comprising lines extending directly away from or toward the user, or perpendicular to the direction, may be drawn on the display screen 12 with lines that are purely in the column direction or purely in the row direction thereby avoiding aliasing effects for such lines. Real life images which it is often desired to show with the display screen 12 often include such lines either directly away from or toward the user's viewpoint, or perpendicular to direction, and accordingly the ability to draw such lines at a higher quality and free of aliasing effects is advantageous.

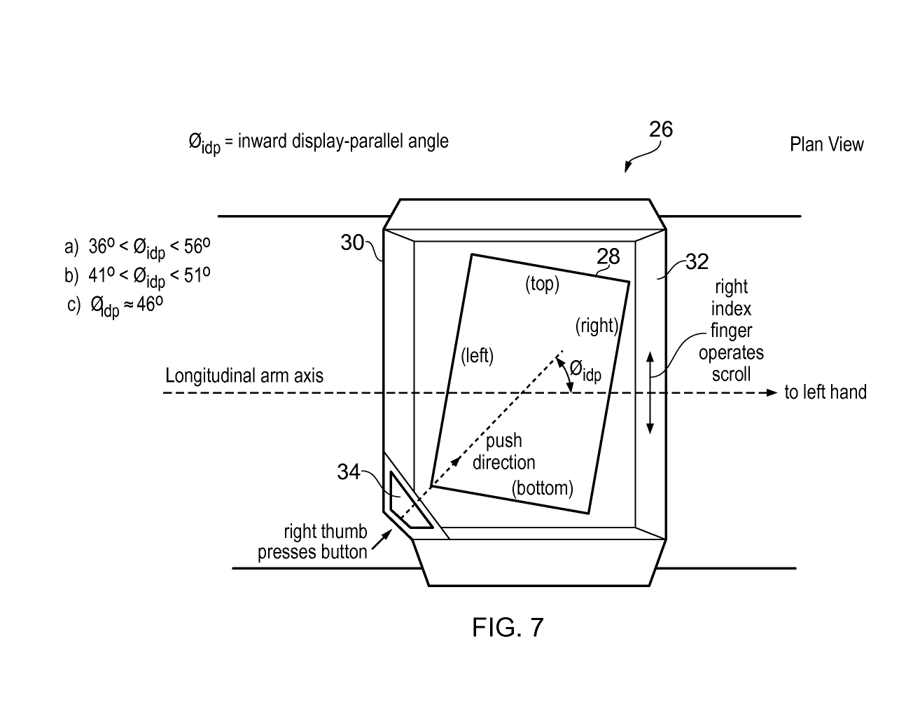

FIG. 7 schematically illustrates a wrist worn device 26 in the form of a smart watch including a rotated display screen 28 within the device body 30. The wrist worn device 26 also includes a scroll sensor 32 disposed proximal to a right portion of the display screen 28 as viewed by the user. A button sensor 34 is disposed proximal to a lower left portion of the display screen 28 as viewed by the user. In use, when such a wrist worn device 26 is worn on a user's left arm and operated with a user's right hand, the user's right index finger naturally falls upon the touch sensor 32 and the user's right thumb falls upon the button sensor 34. The right index finger can be used to provide a sliding touch input along the scroll sensor 32 and the user's right thumb to provide a push input to the button sensor 34.

As illustrated, the push input to the button sensor 34 has a push vector with non zero components directed toward a top portion of the display screen 28, a right portion of the display screen 28 and into the surface of the display screen 28 normal to the display screen 28. The push vector is thus directed across the face of the display screen 28 and into the face of the display screen 28. This is a direction in which it is natural for a user's right thumb to push the button sensor 34 when the user's right index finger is curled around the right hand edge of the wrist worn device 26 and the user's thumb is resting upon the button sensor 34.

As illustrated, the angle of the push vector measured in the surface of the display screen 28 may be termed the inward display-parallel angle Ø_{idp} as shown on FIG. 7. This inward display-parallel angle may have a value between 36 and 56 degrees. In some embodiments, it may have a value between 41 degrees and 51 degrees. In particular embodiments the inward display-parallel angle may be 46 degrees.

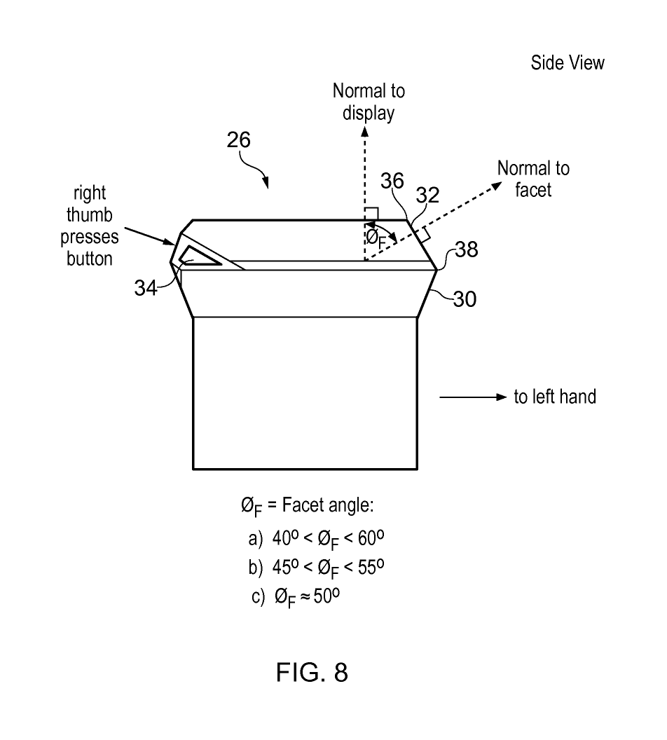

FIG. 8 is a side view of the wrist worn device 26. In this view it may be seen that the touch sensor 32 is disposed on a facet of the display body 30 which has facet edges 36, 38 running parallel to the sliding touch input direction. These facet edges 36, 38 may be felt with a user's index finger when applying such a sliding touch input and accordingly guide the user's finger along the scroll sensor 32 between the two facet edges 36, 38.

As illustrated in FIG. 8, the facet bearing the touch sensor 32 is formed such that it has a facet angle between an outward normal to the facet and an outward normal to the display screen 28 given by a facet angle Ø_{f}. In order to improve the ergonomics of the wrist worn device 26 this facet angle has a value between 40 and 60 degrees. In some embodiments the facet angle has a value between 45 and 55 degrees. In particular embodiments the facet angle is substantially 50 degrees.

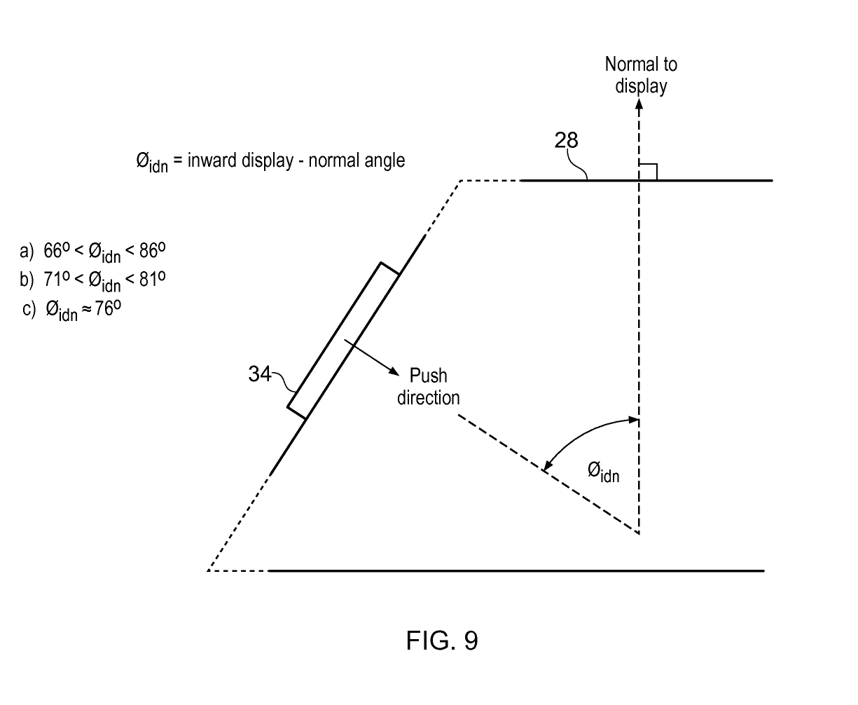

FIG. 9 schematically illustrates how the push direction of the button sensor 34 is directed inwardly towards a normal to the display screen 28. In particular, the push direction is oriented toward the normal to the display 28 at an inward display-normal angle Ø_{idn} as illustrated in FIG. 9. A user's thumb naturally falls upon the button sensor 34 and pushes at such an inward display-normal angle from its resting position when the thumb is placed on the button sensor 34 and the index finger is curled around the edge of the watch so as to be in contact with the touch sensor 32. This makes operation of the button sensor 34 more natural and ergonomic.

This inward display-normal angle Ø_{idn} in some embodiments is between 66 and 86 degrees. In some embodiments the inward display-normal angle Ø_{idn} is between 71 degrees and 81 degrees. In particular embodiments, the inward display-normal angle Ø_{idn} is substantially 76 degrees.

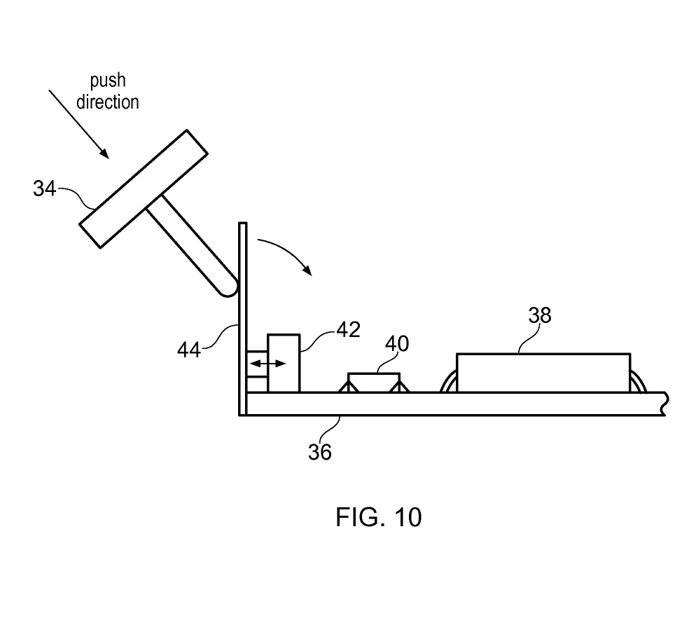

FIG. 10 schematically illustrates how the push direction in which the button sensor 34 moves may be converted into a motion which may be more conveniently sensed by the wrist worn device 26. The wrist worn device 26 includes a printed circuit layer 36 (such as a flexible circuit, or in some embodiments a rigid circuit board). Circuit components 38, 40 are fixed to the printed circuit layer 36. A printed circuit button 42 is fixed to a major surface of the printed circuit layer 36 as illustrated. A lever 44 is also pivotally fixed to the printed circuit layer 36 and is disposed relative to the printed circuit button 42 and the button sensor 34 such that the button sensor 34 bears upon the lever 44 when pushed in the push direction to rotate the lever 44 about its pivot axis, where it is joined to the printed circuit 36, and thereby to actuate the printed circuit button 42.

Thus, the push direction in which the button sensor 34 is actuated has its push direction converted by the lever 44 into a motion in a direction suited for sensing by the printed circuit button 42. Without the lever 44, the end of the button sensor 34 may move too much in a direction perpendicular to the major surface of the printed circuit layer 36 such that it would not make proper contact with the printed circuit button 42 in a reliable fashion taking into account manufacturing tolerances and wear-and-tear within the mechanism.

It will be appreciated that FIG. 7 illustrates a wrist worn device 26 with a scroll sensor 32 and a button sensor 34 positioned and oriented for ergonomic operation by a user's right hand when the wrist worn device 26 is worn on a user's left arm. A complementary aspect of this present invention provides a wrist worn device suitable for wearing on a user's right arm and which is a mirror image of the wrist worn device 26 illustrated in FIG. 7. In this case the scroll sensor is proximal to a left portion of the display screen when viewed by the user and the button sensor is proximal to a lower right portion of the display screen 28 when viewed by the user. The touch sensor manipulated by the user's left index finger and the button sensor would be manipulated by the user's left thumb. The inward display-normal angle, the inward display-parallel angle and the facet angle may all have ranges and values as previously mentioned for the wrist worn device 26 adapted for wearing on the user's left arm.

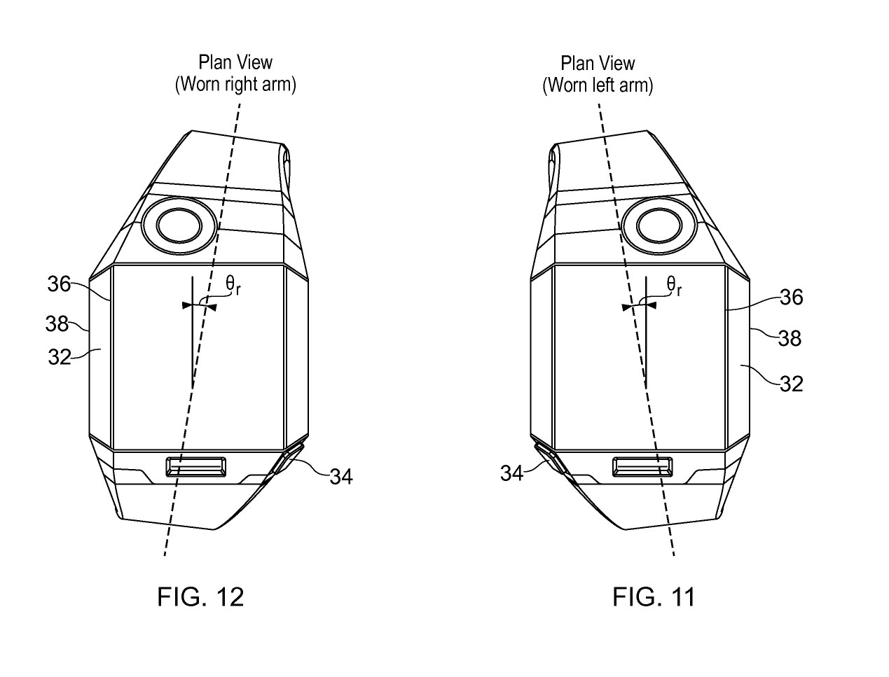

FIGS. 11 to 24 of the accompanying drawings illustrate two versions of the wrist worn device in the form of a smart watch. The version illustrated in FIGS. 11, 13, 15, 17, 19, 21 and 23 is shaped/configured/adapted for wearing on a user's left arm with the display screen rotated by a rotation angle ⊖ᵣ to facilitate viewing when worn on the left arm and with the touch sensor 32 and the button sensor 34 positioned to allow more ergonomic operation by a user's right hand. A complementary embodiment of the wrist worn device in the form of a smart watch is illustrated in FIGS. 12, 14, 16, 18, 20, 22, and 24 and is shaped/configured/adapted so as to be worn on a user's right arm. It will be appreciated that the shape and orientation of the strap and device body control the resting position of the wrist worn device on the user's arm. In the example embodiment illustrated in FIGS. 11 to 24 both the display screen and the device body are rotated relative to the arm's axis and so the display screen appears non-rotated relative to the device body.

FIGS. 11 and 12 illustrate a plan view of the wrist worn devices. As can be seen, the dashed line is perpendicular to the inner faces of the watch strap and accordingly perpendicular to the longitudinal arm axis when the wrist worn device is at its resting position on the arm. The display screen is rotated clockwise relative to this dashed line in the embodiment of FIG. 11 for wearing on a user's left arm and is rotated anti-clockwise relative to this line in the embodiment of FIG. 12 intended for wearing on the user's right arm. It will be appreciated that the shape and orientation of the strap and device body control the resting position of the wrist worn device on the user's arm. In the example embodiment illustrated in FIGS. 11 to 24 both the display screen and the device body are rotated relative to the arm's axis and so the display screen appears non-rotated relative to the device body.

FIG. 11 illustrates the scroll sensor 32 positioned on a facet at the right side of the display screen with the button sensor 34 positioned on a facet located at a lower left portion of the display screen. The facet for the touch sensor 32 has two facet edges 36, 38 which guide the motion of the user's right index finger when providing a touch input.

FIG. 12 illustrates the touch sensor 32 disposed at a left side of the display screen and the button sensor disposed at a lower right side of the display screen. The touch sensor 32 is positioned to be used by a user's left index finger and the button sensor 34 is positioned to be used by a user's left thumb when the smart watch of FIG. 12 is used on a user's right arm.

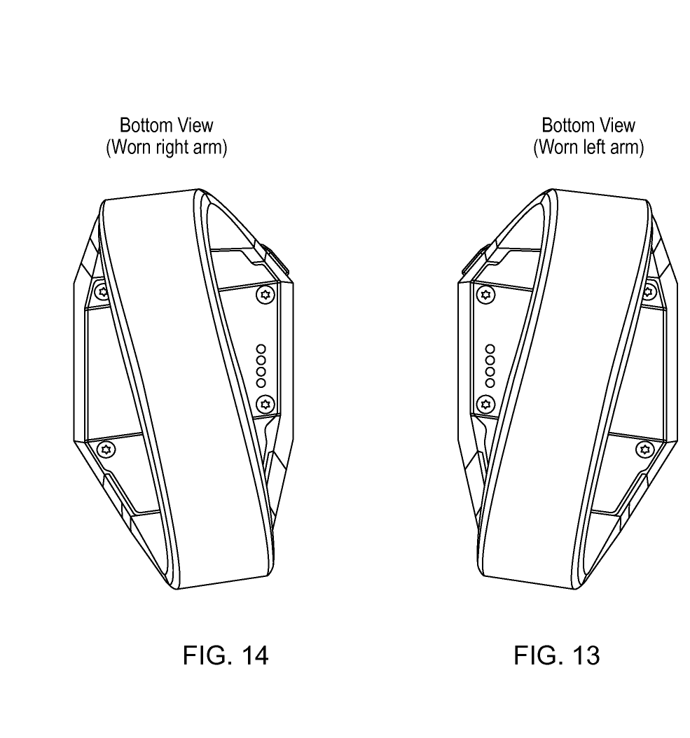

FIGS. 13 and 14 illustrate bottom views of the smart watches of FIGS. 11 and 12 respectively. These views show the S-shaped form of the strap which serves to hold both the device body and the display screen at a rotated resting position relative to the axis of the user's arm. The strap is asymmetric relative to the device body and the left arm strap and the right arm strap have different shapes to respectively provide clockwise and anti-clockwise rotated positions of the display screen in use.

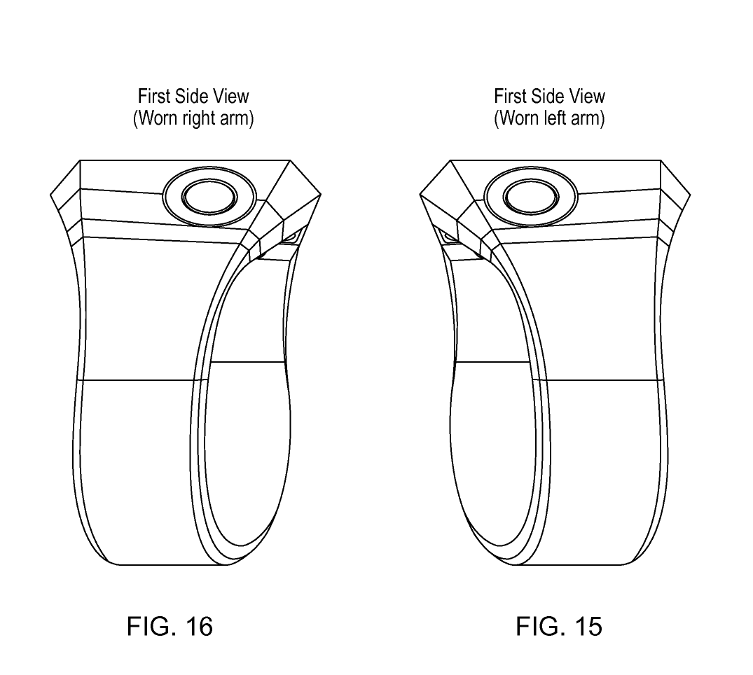

FIGS. 15 and 16 illustrate first side views of the smart watches of FIGS. 11 and 12 respectively.

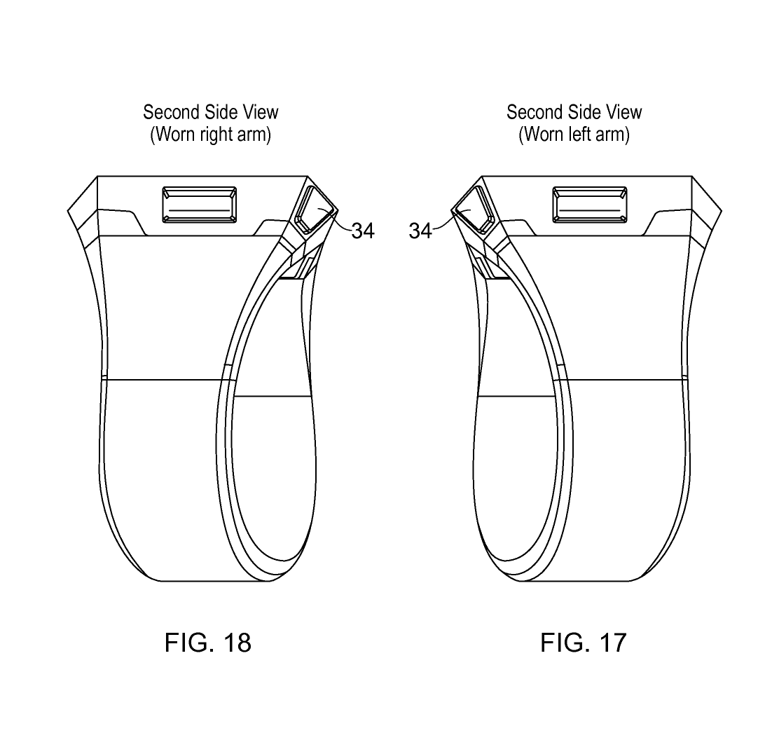

FIGS. 17 and 18 illustrate second side views of the smart watches of FIGS. 11 and 12 respectively.

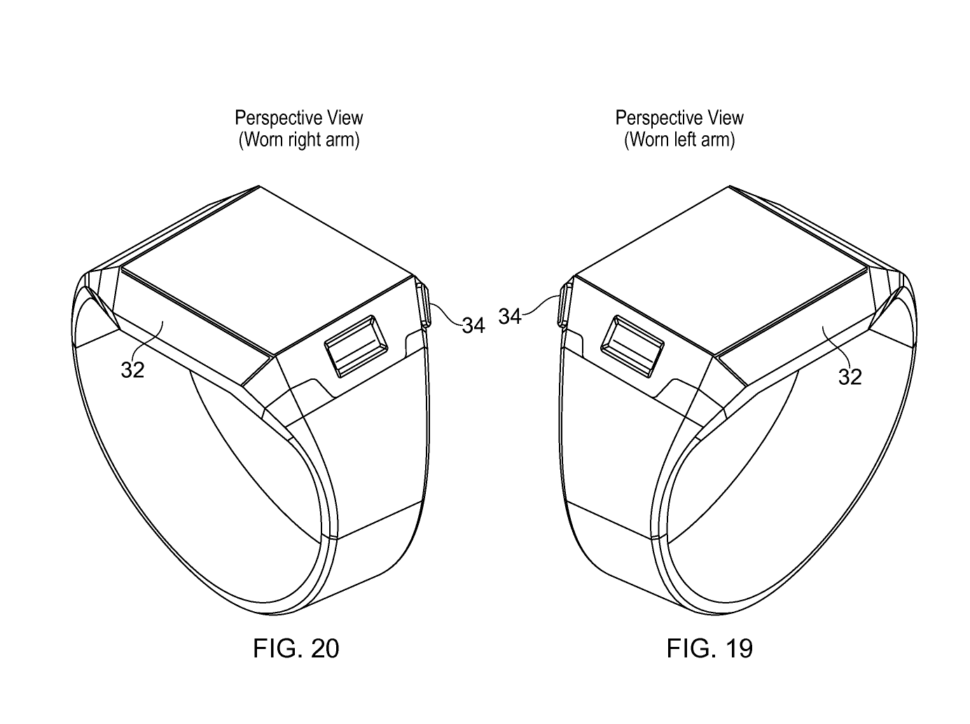

FIGS. 19 and 20 illustrate perspective views of the smart watches of FIGS. 11 and 12 respectively.

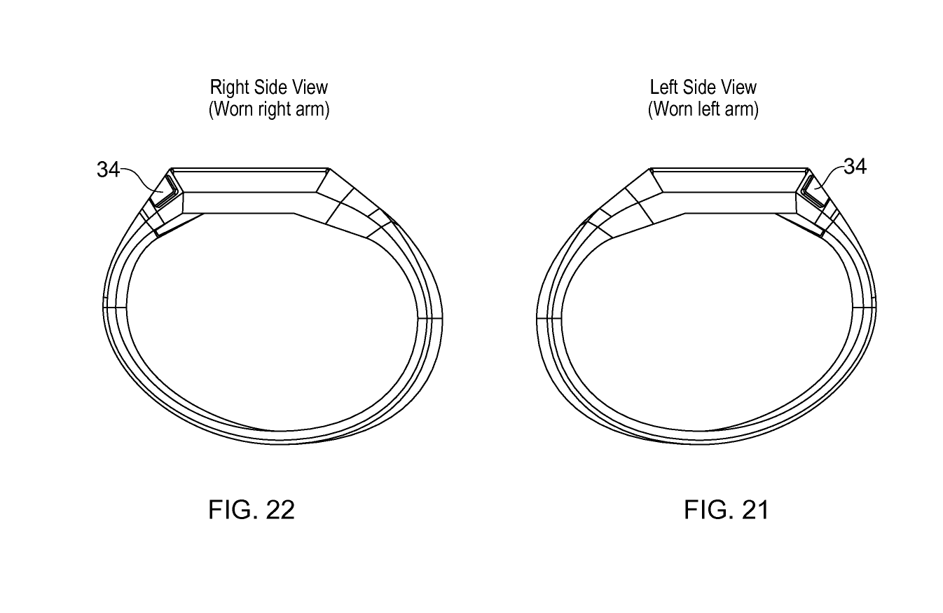

FIG. 21 illustrates a left side view of the smart watch of FIG. 11. FIG. 22 illustrates a right side view of the smart watch of FIG. 12.

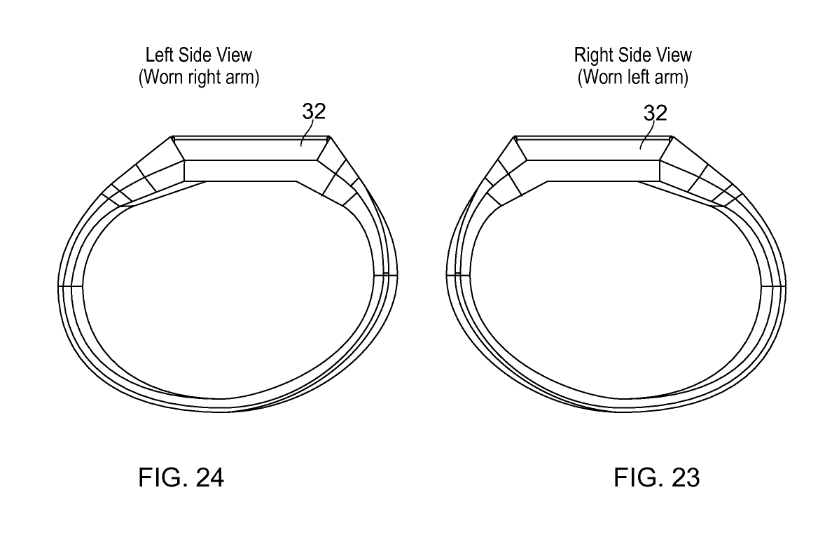

FIG. 23 illustrates a right side view of the smart watch of FIG. 11. FIG. 24 illustrates a left side view of the smart watch of FIG. 12.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A wrist worn device for wearing on a user's arm, said wrist worn device comprising:
a device body having a main face bearing a display and surrounded by body edges;
a scroll sensor disposed on a first edge of said device body and configured to detect a sliding touch input, said first edge being proximal to a left or right portion of said display relative to a viewing direction of said display; and
a button sensor disposed on said device and configured to detect a push input.

2. A wrist worn device as claimed in claim 1, wherein
said scroll sensor is disposed on a first edge of said device body and configured to detect a sliding touch input, said first edge being proximal to a right portion of said display relative to a viewing direction of said display; and
wherein said button sensor is disposed at a button position on said device, said button position being proximal to a lower left portion of said display relative to a viewing direction of said display.

3. A wrist worn device as claimed in claim 1, wherein
said scroll sensor is disposed on a first edge of said device body and configured to detect a sliding touch input, said first edge being proximal to a left portion of said display relative to a viewing direction of said display; and
wherein said button sensor is disposed at a button position on said device, said button position being proximal to a lower right portion of said display relative to a viewing direction of said display.

4. A wrist worn device as claimed in claim 1, wherein said scroll sensor extends along a facet of said device body at said first edge, said facet having at least one facet edge parallel to a direction of said sliding touch input so as to guide said sliding touch input.

5. A wrist worn device as claimed in claim 4, wherein said facet has two parallel facet edges parallel to said sliding touch input with said scroll sensor disposed therebetween.

6. A wrist worn device as claimed in claim 5, wherein a facet angle is an angle between a normal to said display and a normal to said facet and said facet angle has a value between 40 and 60 degrees.

7. A wrist worn device as claimed in claim 6, wherein said facet angle has a value between 45 and 55 degrees.

8. A wrist worn device as claimed in claim 7, wherein said facet angle is substantially 50 degrees.

9. A wrist worn device as claimed in claim 2, wherein said push input has a push vector with non-zero components towards:
a top portion of said display;
a right portion of said display; and
into said display parallel to a normal to said display.

10. A wrist worn device as claimed in claim 3, wherein said push input has a push vector with non-zero components towards:
a top portion of said display;
a left portion of said display; and
into said display parallel to a normal to said display.

11. A wrist worn device as claimed in claim 10, wherein an inward display-normal angle is an angle between said push vector and said normal to said display and said inward angle has a value between 66 and 86 degrees.

12. A wrist worn device as claimed in claim 11, wherein said inward display-normal angle has a value between 71 and 81 degrees.

13. A wrist worn device as claimed in claim 12, wherein said inward display-normal angle is substantially 76 degrees.

14. A wrist worn device as claimed in claim 1, comprising
a strap coupled to said device body and configured to hold said wrist worn device to said user's arm, said wrist worn device being held in a resting position relative to said user's arm and a longitudinal arm axis of said user's arm.

15. A wrist worn device as claimed in claim 14, wherein an inward display-parallel angle is an angle between a component of said push vector parallel to a face of said display proximal to said push button and a direction of said longitudinal arm axis projected into said face proximal to said push button, said inward display-parallel angle having a value between 36 and 56 degrees.

16. A wrist worn device as claimed in claim 15, wherein said inward display-parallel angle has a value between 41 and 51 degrees.

17. A wrist worn device as claimed in claim 16, wherein said inward display-parallel angle is substantially 46 degrees.

18. A wrist worn device as claimed in claim 9, comprising
a printed circuit layer within said device body, said printed circuit layer having a major surface and a printed-circuit button fixed to said major surface; and
a lever fixed to said printed circuit layer and bearing upon said printed-circuit button;
wherein said push input bears upon said lever and said lever and said printed-circuit button are configured such that said push input drives a pivoting motion of said lever such that said lever actuates said printed-circuit button.

19. A wrist worn device for wearing on a user's arm, said wrist worn device comprising:
device body means for housing device components, said device body means having a main face bearing display means for displaying an image, said device body means being surrounded by body edges;
scroll sensor means for detecting sliding touch input, said scroll sensor means being disposed on a first edge of said device body means, said first edge being proximal to a left or right portion of said display means relative to a viewing direction of said display means; and
button sensor means disposed on said device body and configured to detect a push input.
